(19) United States
(12) Patent Application Publication
(10) Pub. No.: US 2017/0233199 A1
(43) Pub. Date: Aug. 17, 2017

(54) BAKERY TRAY STACKER

(71) Applicant: Rehrig Pacific Company, Los Angeles, CA (US)

(72) Inventor: Philip A. King, Sugar Hill, GA (US)

(21) Appl. No.: 15/411,195

(22) Filed: Jan. 20, 2017

Related U.S. Application Data
(60) Provisional application No. 62/405,811, filed on Oct. 7, 2016.
(60) Provisional application No. 62/281,169, filed on Jan. 20, 2016.

(51) Int. Cl. B65G 57/30; B65G 59/06

(52) U.S. Cl. CPC B65G 57/30; B65G 59/06; B65G 2814/0304; B65G 2814/0308

(57) ABSTRACT

A stacker includes a base and a vertical structure supported by the base. A lift unit includes a support surface for engaging and lifting a tray from a stack of trays. The lift unit is mounted to the vertical structure and movable vertically relative to the vertical structure. A lifting mechanism selectively raises and lowers the lift unit relative to the vertical structure. The support surface may be formed on first and second projections configured to engage first and second handle openings of a tray. The stacker facilitates several stacking/destacking methods for more easily converting a stack of trays at a first height to a stack of trays at a second height. For example, the first height may be more convenient or appropriate for use in a bakery, while the second height may be more efficient for loading in a truck.

### BACKGROUND

Stackable plastic trays are often used for shipping goods, such as bakery items. A common practice in the baking industry is to limit the stack height to 70-90″ for bakery trays leaving a bakery. However, for shipping efficiency, the trailer delivering the loaded bakery trays to the distribution center or retail location should ideally be cubed out to the internal height of the trailer, which may be 100-105″.

### SUMMARY

A stacker includes a base and a vertical structure supported by the base. A lift unit includes a support surface for engaging and lifting a tray from a stack of trays. The lift unit is mounted to the vertical structure and movable vertically relative to the vertical structure. A lifting mechanism selectively raises and lowers the lift unit relative to the vertical structure. The support surface may be formed on a first projection configured to engage a first handle opening of a tray. A second projection may be configured to engage a second handle opening in the tray opposite the first handle opening. The stacker facilitates several stacking/destacking methods for more easily converting a stack of trays at a first height to a stack of trays at a second height. For example, the first height may be more convenient or appropriate for use in a bakery, while the second height may be more efficient for loading in a truck.

### BRIEF DESCRIPTION OF THE DRAWINGS

FIG. 1 is a perspective view of a stacker according to one embodiment.

FIG. 2 is a section view through the stacker of FIG. 1, looking downward.

FIG. 3 is similar to the view of FIG. 2, with a tray on the lifting unit.

FIG. 4 is similar to the view of FIG. 3, with the lifting unit engaging the tray in a stack of trays.

FIGS. 5A-F show a series of six steps for down-stacking half-stacks of trays.

FIGS. 6A-H show a series of eight steps for down-stacking from the middle of a stack of trays.

FIGS. 7A-F show a series of six steps for up-stacking half-stacks of trays.

FIGS. 8A-H show a series of eight steps for up-stacking into the middle of a stack of trays.

FIG. 9 shows an optional carriage on a stacker according to a second embodiment.

FIG. 10 is a partially exploded view of the carriage of FIG. 9.

FIG. 11 is a section, side view of a lower portion of the stacker of FIG. 9 as it is engaging a dolly.

FIG. 12 is similar to the view of FIG. 11 with the stacker engaged with the dolly.

### DETAILED DESCRIPTION OF PREFERRED EMBODIMENTS

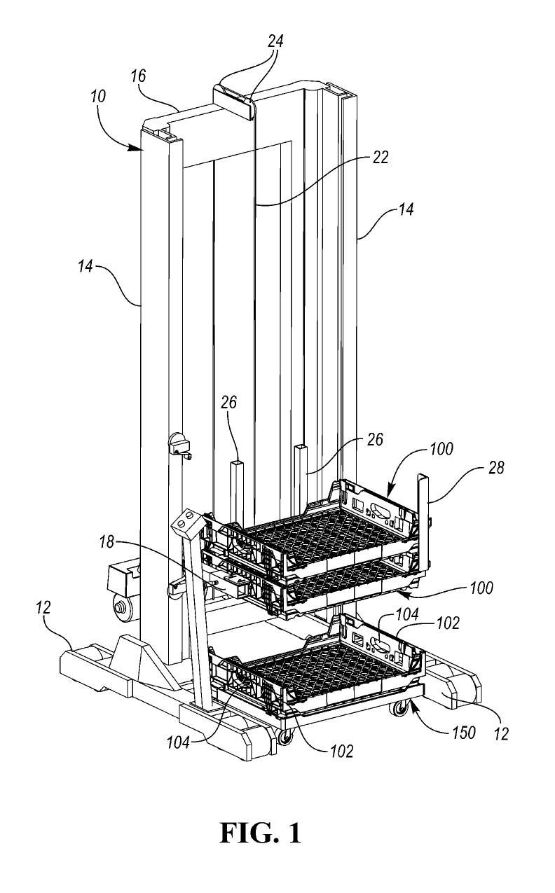

A stacker 10 according to one example embodiment is shown in FIG. 1. The stacker 10 includes a base including a pair of base supports 12 and a vertical structure extending upward from the base, wherein the vertical structure includes a pair of parallel vertical supports 14. An upper bracket 16 connects upper ends of the vertical supports 14. A lifting unit 18 is slidably supported on the vertical supports 14 and is slidable vertically relative to the vertical supports 14.

A cable 22 is looped over pulleys 24 at the upper bracket 16 and is connected to the lifting unit 18. The lifting unit 18 includes a pair of rear tip guards 26 extending upward from a rearward portion of the lifting unit 18. At least one front tip guard 28 extends upward at a frontward portion of the lifting unit 18.

The lifting unit 18 can lift a plurality of trays 100 from a stack of trays 100 stacked on a dolly 150. Each of the plurality of trays 100 includes a pair of opposed side walls 102 having handle openings 104 therethrough.

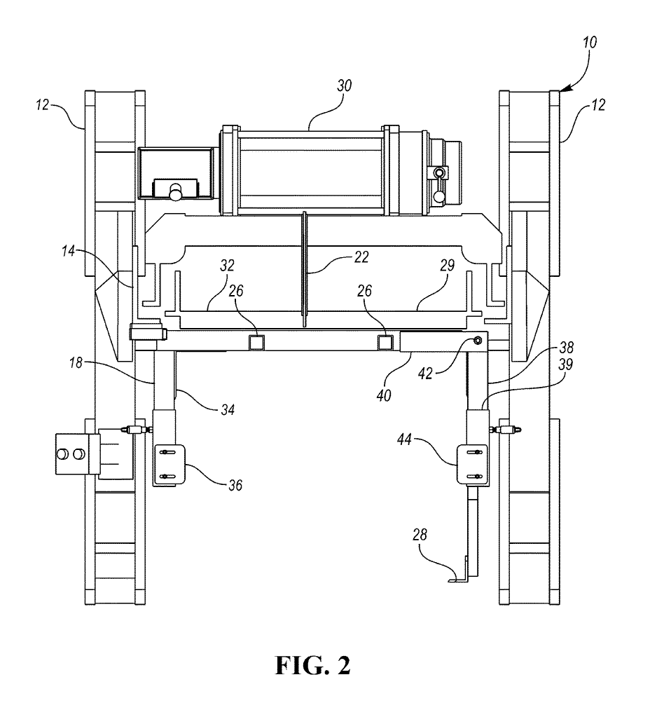

FIG. 2 is a section view through the stacker 10 looking downward toward the lifting unit 18. A lifting mechanism, such as a winch 30, the cable 22 and the pulleys 24 (FIG. 1), is used to selectively lift and lower the lifting unit 18 relative to the vertical supports 14. Alternatively, a motor, hydraulics or manually-powered mechanisms could be used to selectively lift and lower the lifting unit 18. The lifting unit 18 includes a rear portion 32 (such as a metal bar or beam). A fixed arm 34 extends forwardly and perpendicularly from a first side of the rear portion 32. A first support tab 36 or first projection projects inward from the fixed arm 34.

A second, L-shaped arm 38 is pivotably secured to a second side of the rear portion 32. The L-shaped arm 38 includes a first leg 40 overlapping a portion of the rear portion 32 and a second leg 39 projecting perpendicularly and forwardly from the rear portion 32. The L-shaped portion 38 is pivotably secured to the rear portion 32 by a pivot pin 42. A second support tab 44 or second projection projects inward from the second leg 39 of the L-shaped arm 38. The second support tab 44 and the first support tab 36 project toward one another. The support tabs 36, 44 are adjustable on the arms 34, 38 to accommodate different size trays 100. The front tip guard 28, which is an L-shaped cross-section bracket, is mounted at a forward end of the second leg 39 of the L-shaped arm 38. The width of the lift unit 18 may also be adjustable (e.g. by adjusting a length of the rear portion 32).

The rear tip guards 26 project upward from the rear portion 32. The rear portion 32 is secured to a shuttle 29 which is slidably secured to the vertical supports 14.

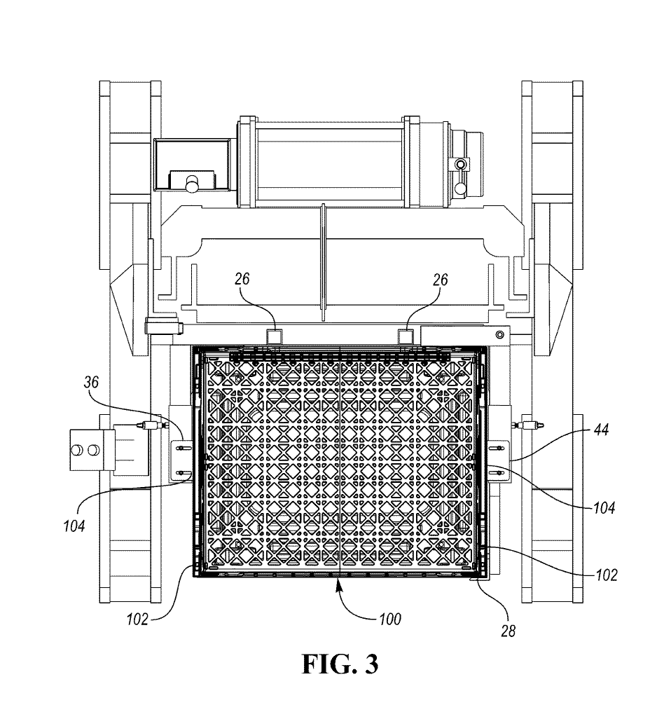

FIG. 3 is a view similar to FIG. 2 with a tray 100 on the lifting unit 18. The first support tab 36 and the second support tab 44 are received in the handle openings 104 of the side walls 102 of the tray 100. Upper surfaces of the first support tab 36 and the second support tab 44 provide support surfaces for engaging the tray 100. The rear tip guards 26 and the front tip guard 28 hold the tray 100 in place.

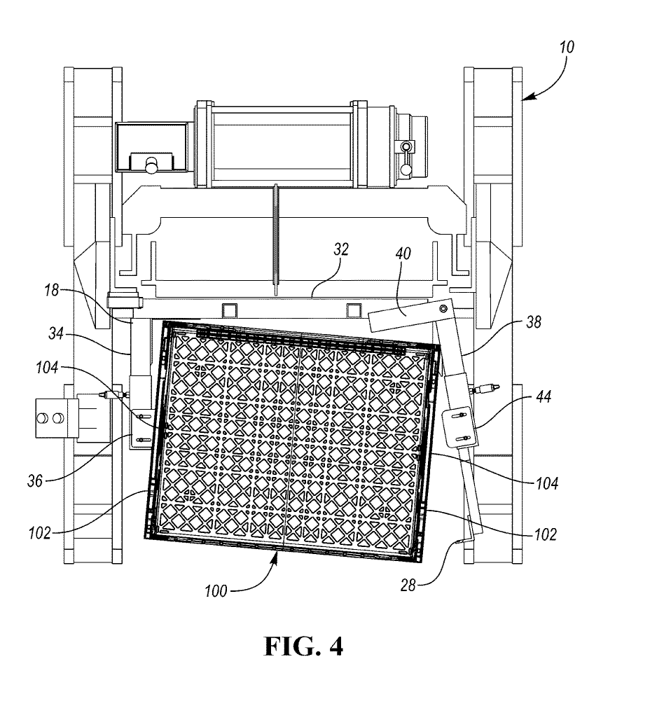

FIG. 4 demonstrates how to engage the lifting unit 18 with one tray 100 in a stack of trays 100. With the L-shaped arm 38 initially in the open position, the stack of trays 100 (only the top tray 100 is visible) is rolled into position (on a dolly 150, e.g. FIG. 1). As the target tray 10 impacts the first leg 40 of the L-shaped arm 38, the L-shaped arm 38 pivots to the secure position. The first support tab 36 is received in one of the handle openings 104 of the tray 100. As the L-shaped arm 38 pivots inward, the second support tab 44 is also then received in the other handle opening 104, as shown in FIG. 3. Magnets may be mounted in the first leg 40 and the rear portion 32 to help retain the L-shaped arm 38 in this position. Alternatively, a manual latch could selectively secure the L-shaped arm 38 in place. By pulling the L-shaped arm 38 outward, the second support tab 44 is removed from the handle opening 104 and the first leg 40 pushes the target tray 100 (and the entire stack of trays 100 and dolly 150 below it) out of the stacker 10. Activation of the lifting mechanism causes the lifting unit 18 to lift the target tray 100 upward by the handle openings 104.

The ability to lift a plurality of trays 100 off of a dolly 150 (FIG. 1) or a stack of a plurality of trays 100, or to lower a plurality of trays 100 onto a plurality of trays 100 or a dolly 150 (FIG. 1), can be used in many ways, some of which are described below.

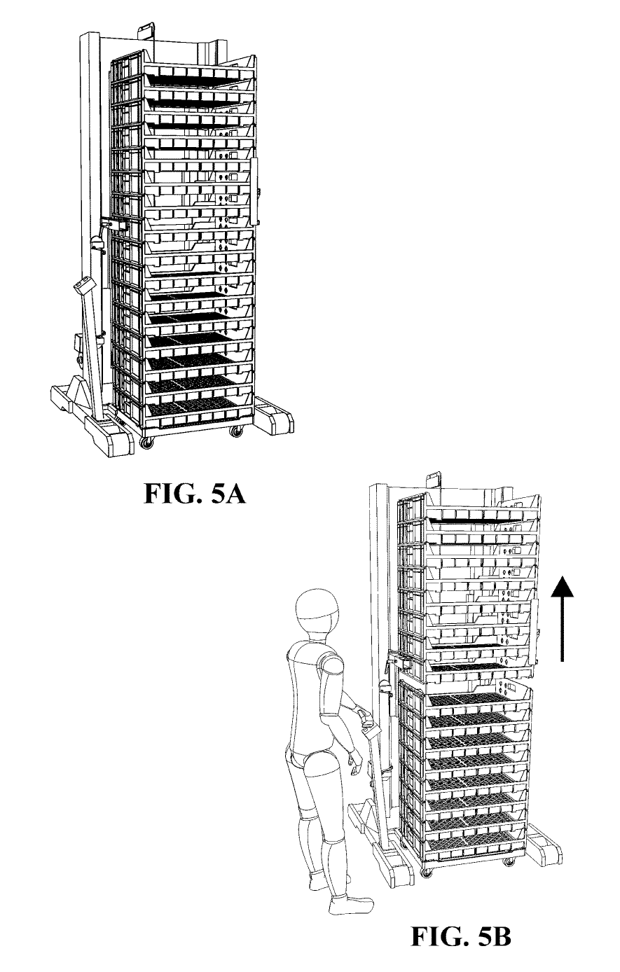

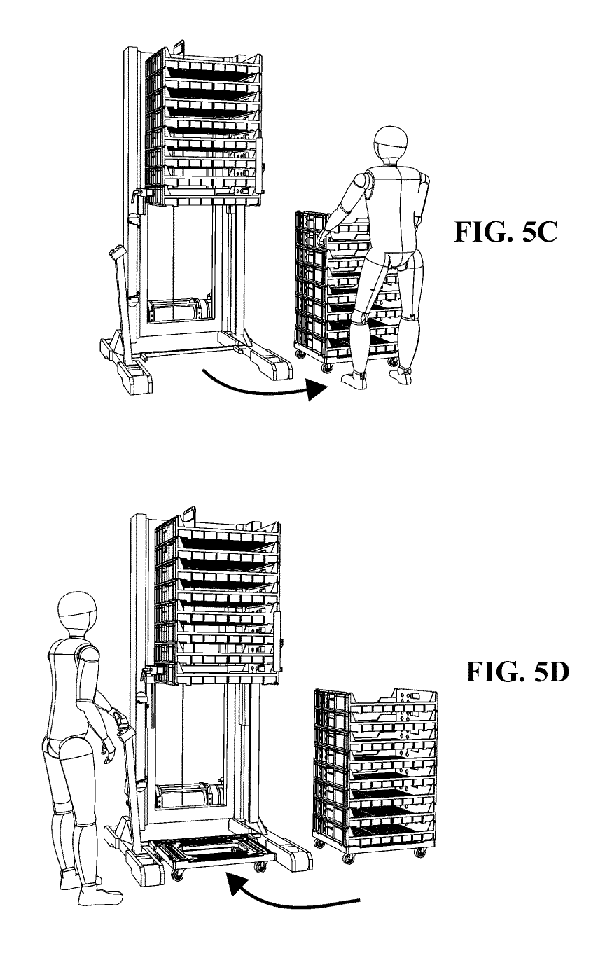

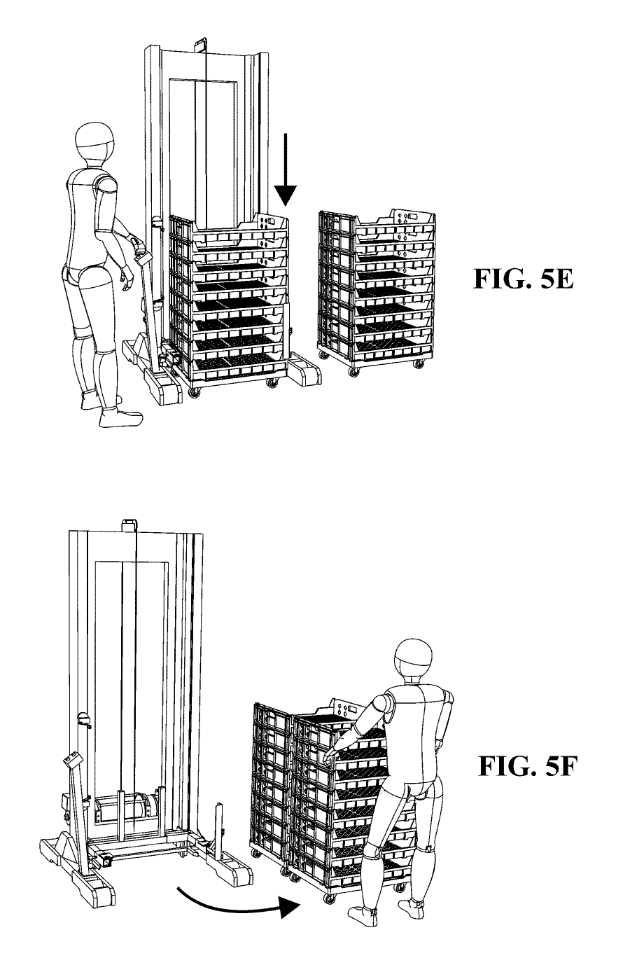

FIGS. 5A-F shows a series of six steps 1-6 for “down-stacking half-stacks” of trays 100. In step 1, a plurality (e.g. 17) of trays 100 stacked on a dolly 150 is rolled into the stacker 10. In step 2, the stacker 10 lifts about half of the trays 100. In step 3, the lower half of the plurality of trays 100 are rolled away on the dolly 150. In step 4, another, empty dolly 150 is placed in the stacker 10 below the trays 100. In step 5, the stacker 10 lowers the trays 100 onto the dolly 150. The dolly 150 and trays 100 are then removed from the stacker 10 in step 6, resulting in two half (approximately) stacks of trays 100 on dollies 150. Downstacking is useful, for example, if a large number of trays 100 stacked on a dolly 150 are delivered from a truck (for max cube out) but smaller stacks of trays 100 are desired. This downstacking method can easily achieve the smaller stacks of trays 100.

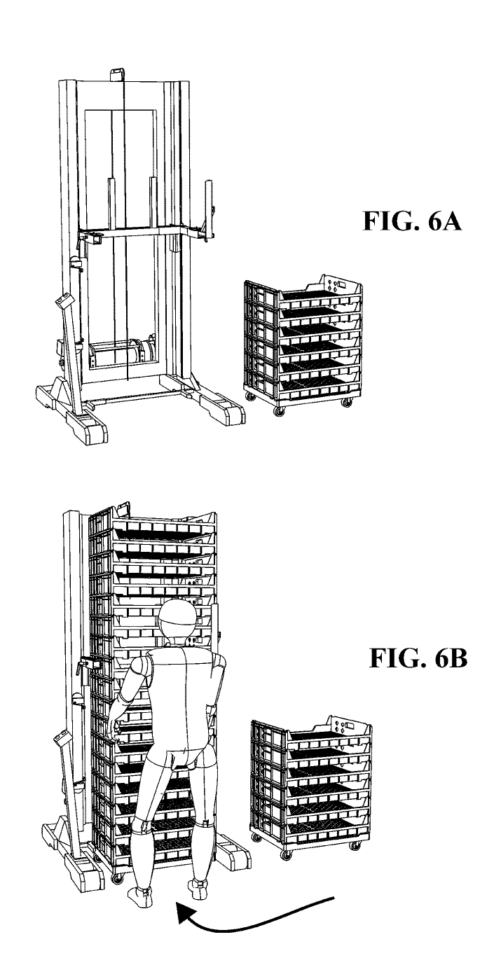

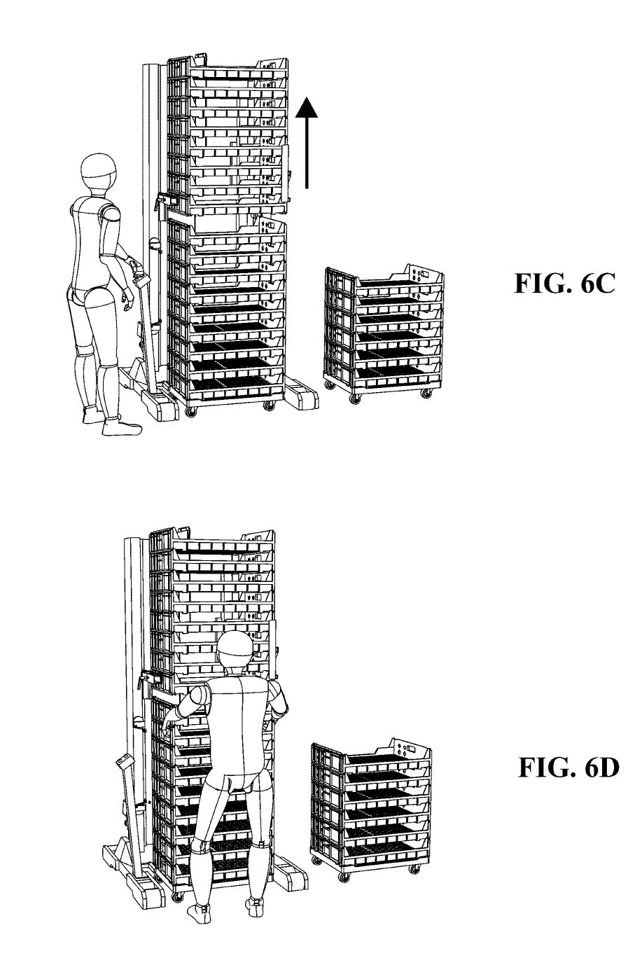

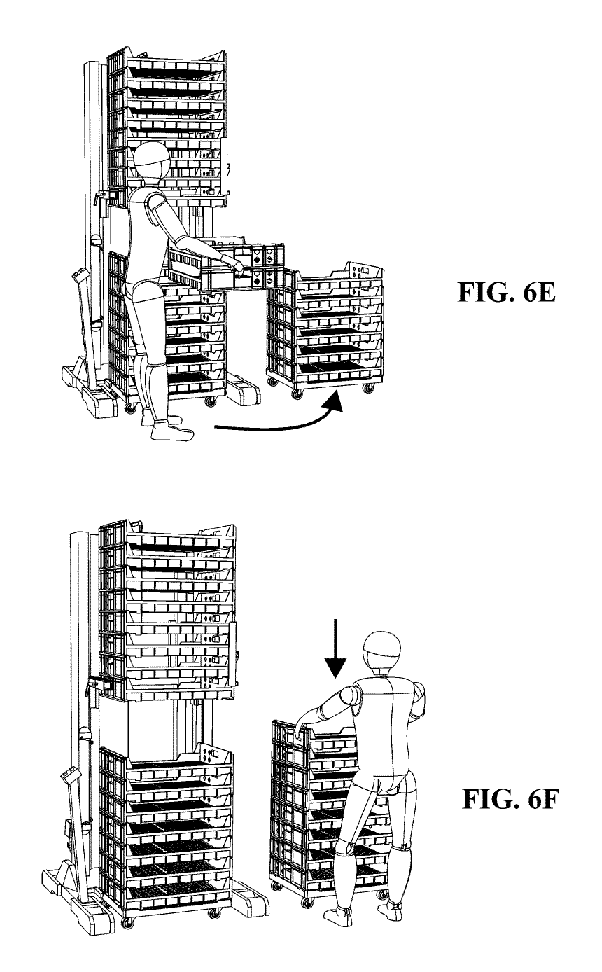

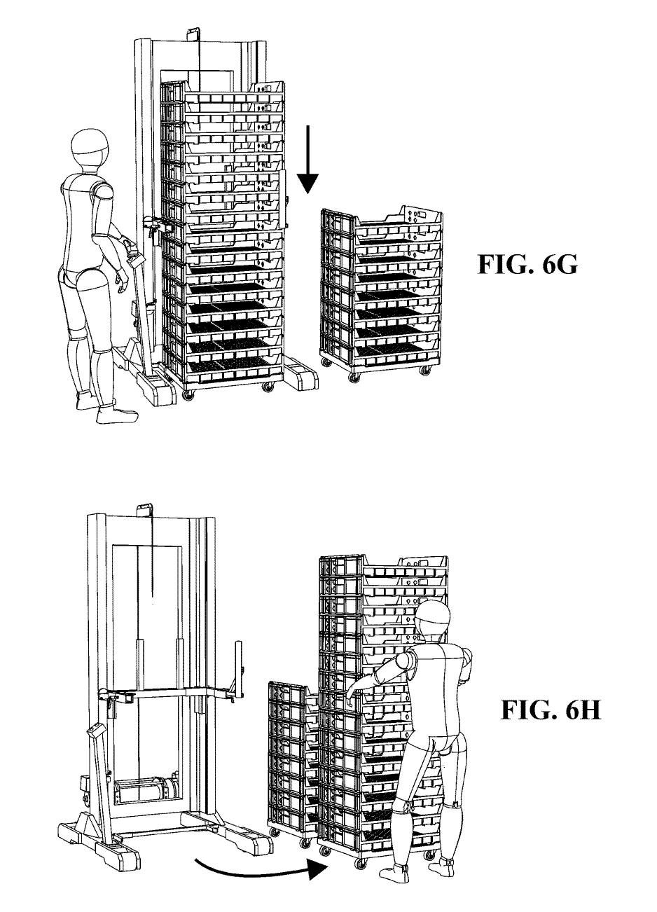

FIGS. 6A-H demonstrate another method for downstacking using the stacker 10. A large stack of trays 100 is moved into the stacker 10 (step 2). A subset of trays 100 is lifted by the stacker 10 (step 3). A user then removes the top two trays 100 of the lower subset of trays 100 (steps 4-5) and places those two trays 100 onto a stack of trays 100 on another dolly 150 (step 6). (Optionally more trays 100 could be removed from the lower subset of trays 100). The stacker 10 then lowers the upper subset of trays 100 back down onto the remainder of the stack (step 7). The resulting stack is then two (or more) trays 100 shorter than it was initially. This can be repeated for more large stacks of trays 100 (e.g. from the truck), until a satisfactorily-sized stack is created with the removed trays 100.

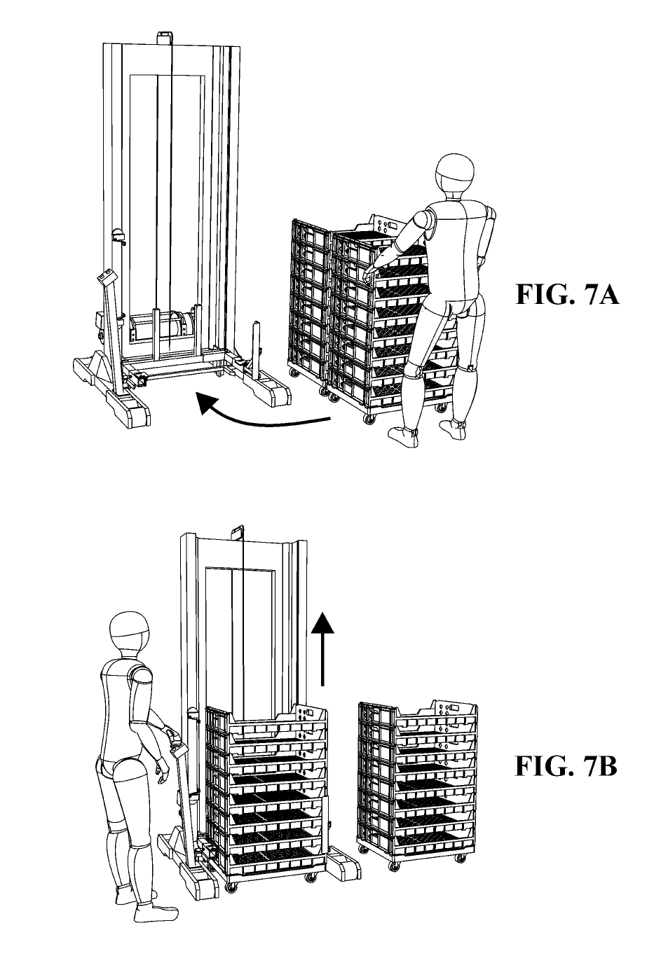

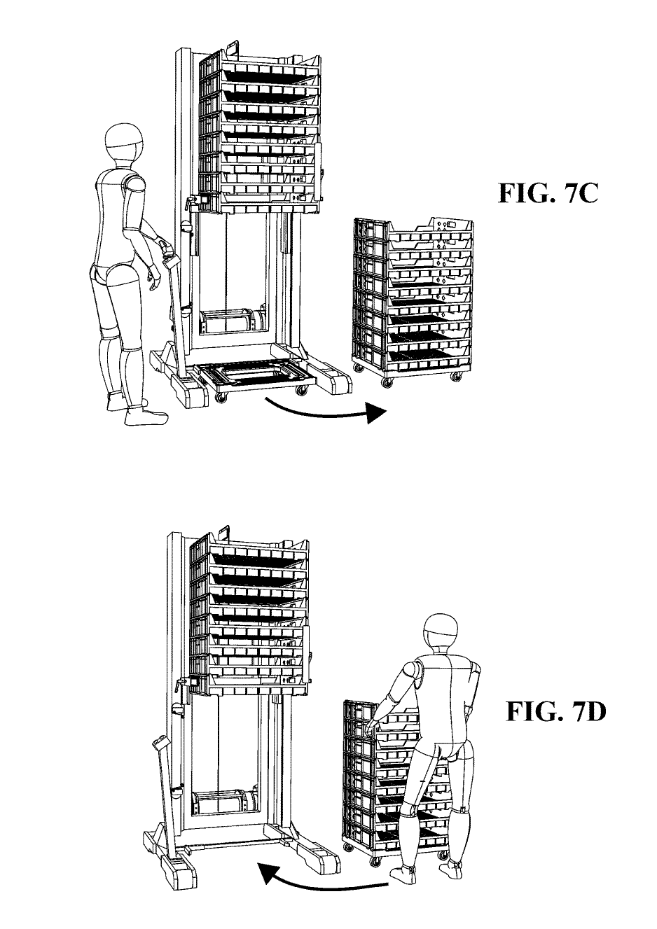

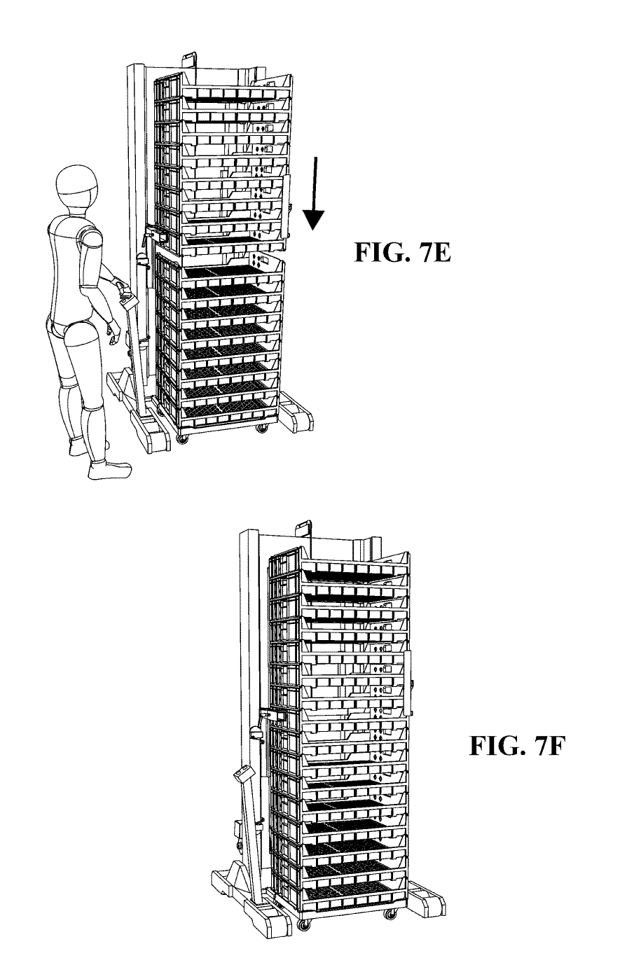

FIGS. 7A-F show a method for upstacking half stacks of trays 100, for example, to increase the height of stacks of trays 100 for max cube out in the truck. A half stack of trays 100 is moved into the stacker 10 (step 1). The trays 100 are lifted from the dolly 150 (step 3) and the dolly 150 is removed. Another half stack of trays 100 are moved into the stacker 10 (step 5) and the upper half stack of trays 100 is lowered onto the lower half stack of trays 100 and dolly 150. The resulting large stack of trays 100 provides max cube out in the truck.

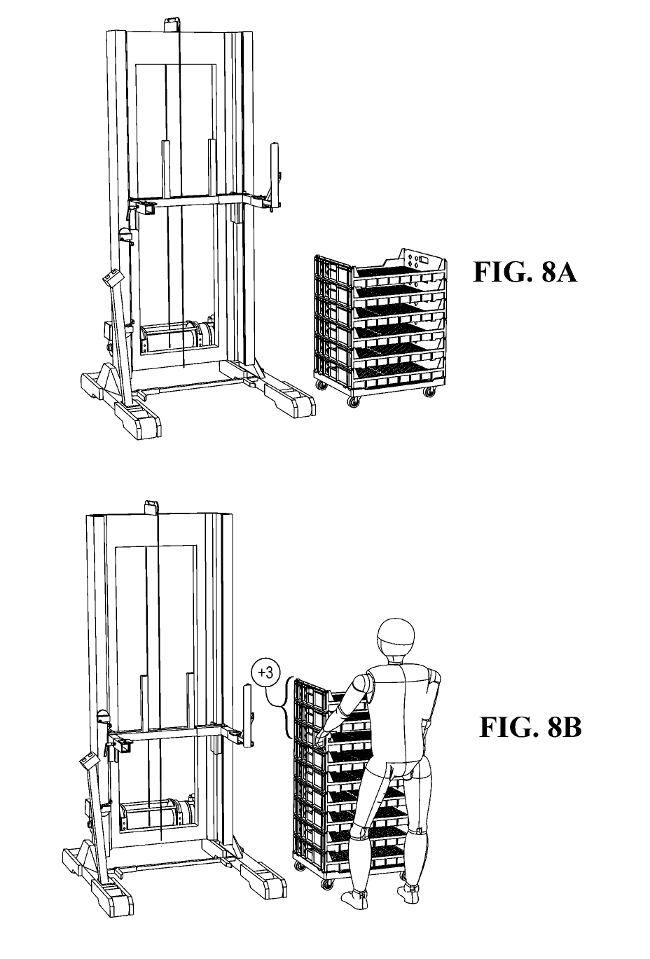

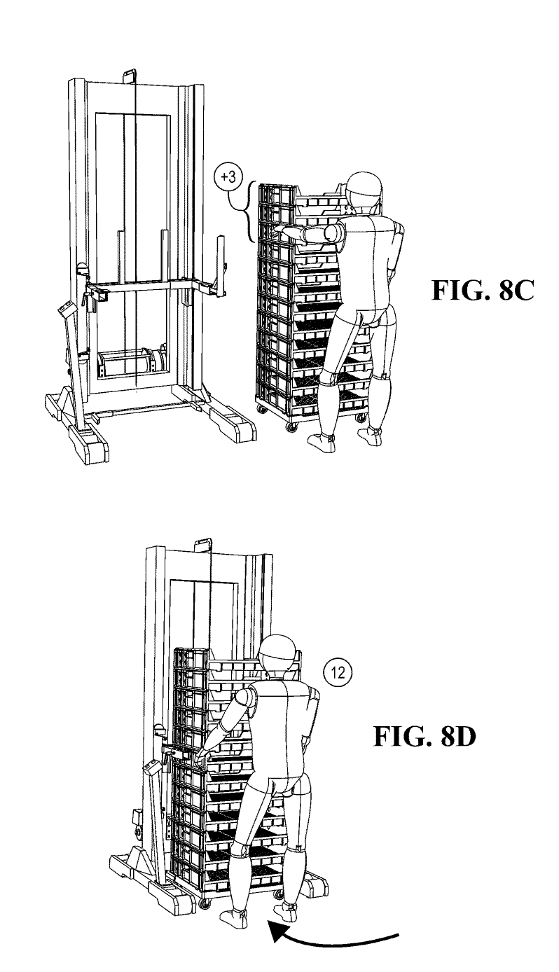

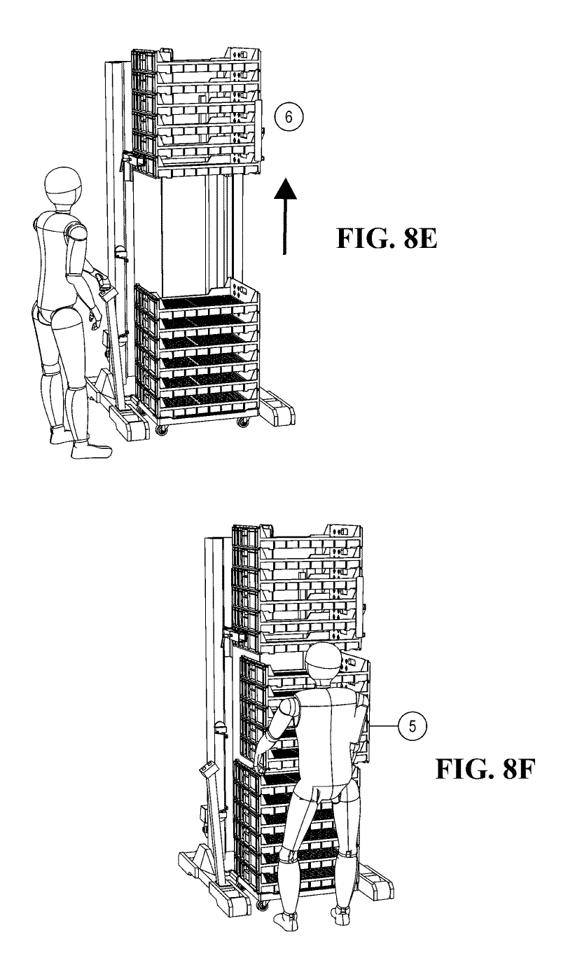

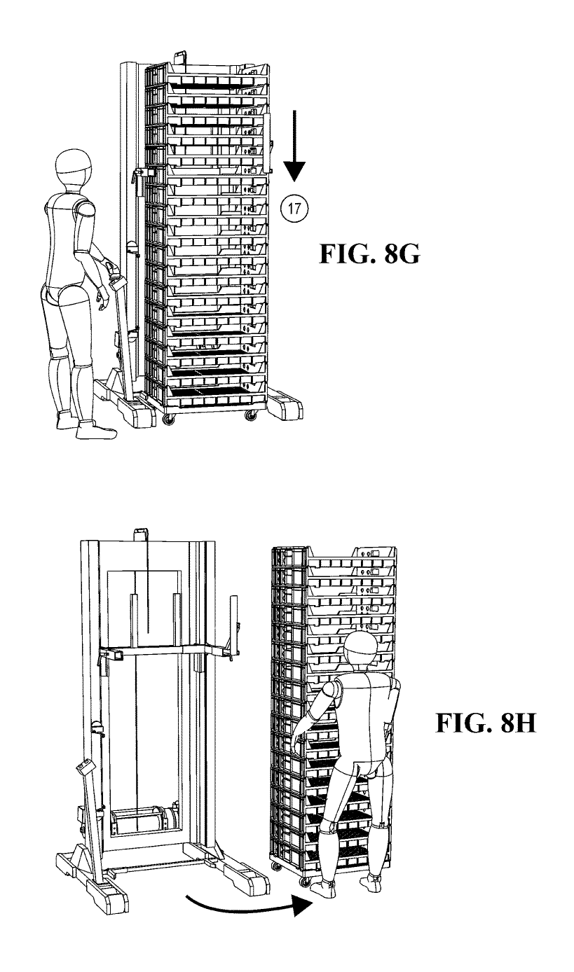

FIGS. 8A-H show another method for upstacking. In steps 2 and 3, a plurality of trays 100 are added to an existing half stack on a dolly 150. When the stack gets too high for a user to add more trays 100 on top, the stacker 10 can be used to permit the user to add trays 100 to the middle of the stack. The stack is placed in the stacker 10 (step 4). An upper plurality of trays 100 is lifted from the stack (step 5) and the user can add trays 100 to the middle (step 6). The upper trays 100 are then lowered onto the stack (step 7). The large stack is then removed from the stacker 10 for loading onto the truck (for example).

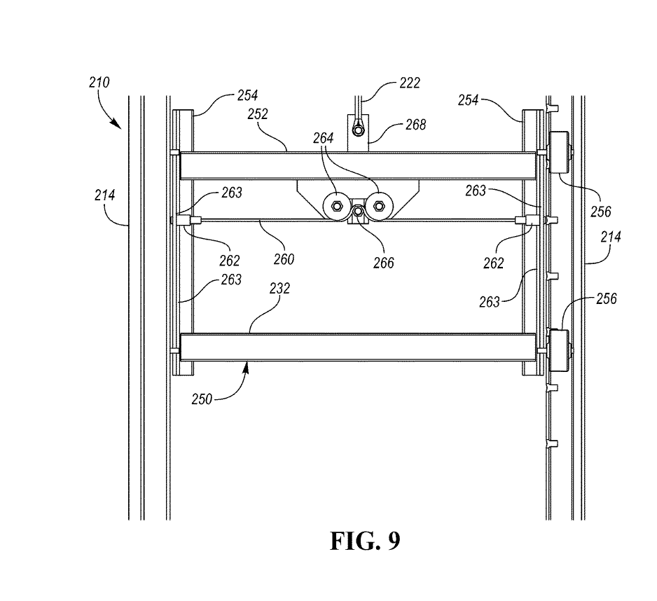

FIG. 9 shows an optional carriage 250 for an alternative stacker 210. The carriage 250 is slidably mounted on the vertical supports 214 and includes the rear portion 232 (which corresponds to the rear portion 32 of the lifting unit 18 of FIGS. 1-4), an upper portion 252 and a pair of outer portions 254 connecting the rear portion 232 to the upper portion 252. A cable 260 extends from one outer portion 254 to the other. At each end, the cable 260 is biased outwardly by a spring pin 262 (a spring biases the pin (or “brake”) and the cable 260 outward). A plurality of holes 263 are formed in the vertical supports 214 and are sized to receive the spring pins 262. A pair of side pulleys 264 are connected to the upper portion 254 above the center of the cable 260. A center pulley 266 (or post) is positioned below the center of the cable 260 between the side pulleys 264 and secured to a center rod 268 slidably mounted to the upper portion 252. In normal operation, as shown in FIG. 9, the lift cable 222 is secured to the rod 268. The weight of the carriage 250 (and anything being lifted by the stacker 210) pulls the center pulley 266 upward, which also pulls the cable 260 upward between the side pulleys 264. This pulls the spring pins 262 inward, disengaging them from the holes 263 in the vertical supports 214 and the carriage 250 can move freely up and down in the vertical supports 214.

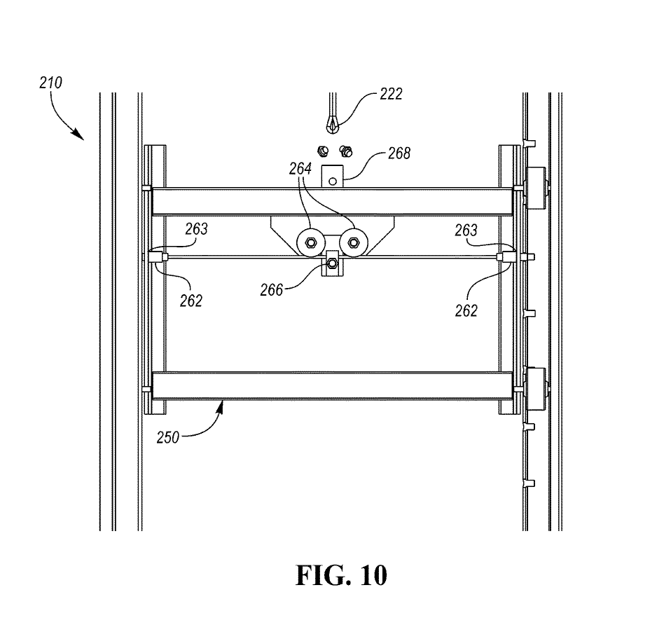

If the lift cable 222 breaks or disconnects, there is no force pulling upward on center pulley 266, and the spring pins 262 are able to pulls ends of the cable 260 outward (thereby forcing center pulley 266 downward) and the spring pins 262 spring outward and engage the vertical supports 214 to brake the carriage 250 (and lifting unit). As soon as the pins align with holes 263 in the vertical supports 214, the spring pins 262 engage the holes 263 and the carriage 250 is locked in place. After the lift cable 222 is repaired or replaced or reconnected, the carriage 250 returns to normal operation. Other than as shown in FIGS. 9 and 10, the stacker 210 may operate the same as the stacker 10 shown in FIGS. 1-8.

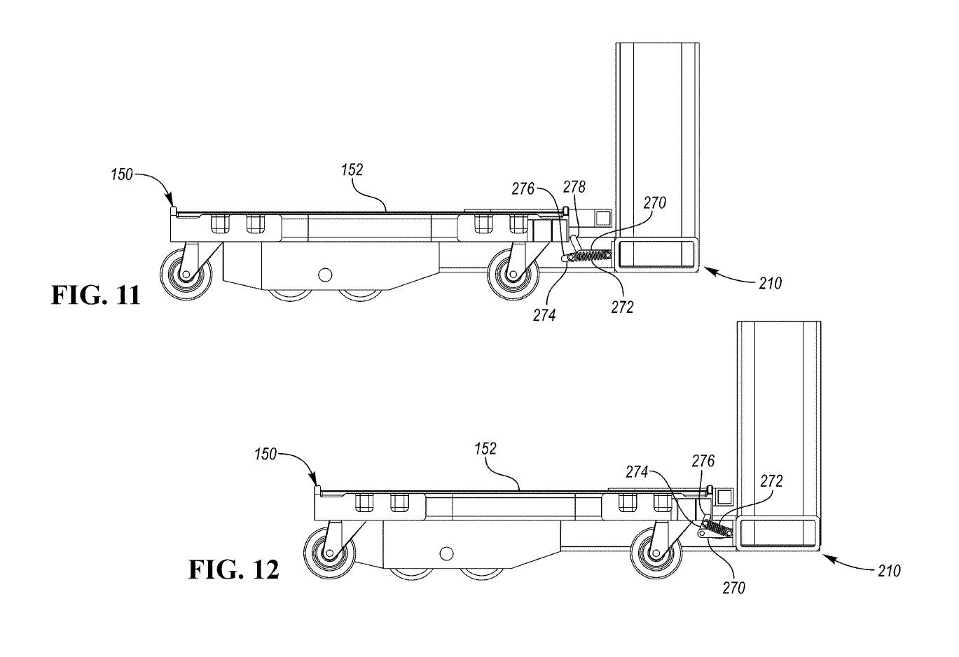

FIGS. 11 and 12 show another optional feature for stacker 210 (or stacker 100). A dolly retainer is secured to the base of the stacker 210. The retainer includes a support arm 270 projecting outward from the base toward the dolly bay. A spring 272 is secured at one end to the base or to the support arm 270 adjacent the base. The spring 272 is secured at its other end to a retention arm 276 of an angled bracket 274. The angled bracket 274 includes the retention arm 276 and a trigger arm 278, which extend relative to one another at a fixed angle (in this example an acute angle of about 70 to 85 degrees).

As shown in FIG. 11, as the dolly 150 is moved into the dolly bay adjacent the stacker 210, the deck 152 of the dolly 150 impacts the trigger arm 278, which overcomes the spring 272 and causes the angled bracket 274 to pivot, first stretching the spring 272 further and then past the peak, such that the spring 272 can retract thereby rotating the retention arm 276 upward behind a lip of the deck 152 of the dolly 150. This provides enough retention to keep the dolly 150 in place while it is loaded with trays 100 (e.g. FIG. 1); however, the user can intentionally push the dolly 150 (loaded or not) out of the dolly bay and overcome the spring 272 and rotate the angled bracket 274 until the retention arm 276 is out of the way of the lip of the deck 152, at which time the retention arm 276 is past its peak and the spring 272 is already shortening again (as shown in FIG. 11).

In accordance with the provisions of the patent statutes and jurisprudence, exemplary configurations described above are considered to represent a preferred embodiment of the invention. However, it should be noted that the invention can be practiced otherwise than as specifically illustrated and described without departing from its spirit or scope.

What is claimed is:

1. A stacker comprising:
a base;
a vertical structure supported by the base; and
a lift unit including a support surface for engaging and lifting a tray from a stack of trays, the lift unit mounted to the vertical structure and movable vertically relative to the vertical structure.

2. The stacker of claim 1 further including a lifting mechanism for selectively raising and lowering the lift unit relative to the vertical structure.

3. The stacker of claim 1 wherein the support surface is formed on a first projection configured to engage a first handle opening of a tray.

4. The stacker of claim 3 wherein the lift unit further includes a second projection configured to engage a second handle opening in the tray opposite the first handle opening.

5. The stacker of claim 4 wherein the second projection is movable between a retracted position where it would not engage the handle opening of the tray and an engaged position where it would engage the handle opening of the tray.

6. The stacker of claim 5 wherein the second projection is mounted on a second arm pivotable between the retracted position and the engaged position.

7. The stacker of claim 2 further including a braking mechanism that resists relative movement between the lift unit and the vertical support based upon the lift unit disconnecting from the lifting mechanism.

8. The stacker of claim 7 further including a lift cable connecting the lift unit to the lifting mechanism, wherein force exerted between the lift unit and the lift cable prevents the braking mechanism from resisting relative movement between the lift unit and the vertical support.

9. The stacker of claim 8 wherein the braking mechanism includes at least one brake spring-biased toward a braking position where it resists relative movement between the lift unit and the vertical support and wherein the force exerted between the lift unit and the lift cable moves the at least one brake away from the braking position.

10. The stacker of claim 9 wherein the at least one brake includes two pins spring-biased toward the vertical structure and engaging holes in the vertical structure when moved toward the braking position.

11. The stacker of claim 1 further including a retention arm on the base configured to selectively retain a dolly adjacent the base.

12. The stacker of claim 11 wherein the retention arm is spring biased toward a retention position where it can engage the dolly to retain the dolly adjacent the base.

13. A method for arranging trays on a dolly including the steps of:
a) lifting an upper plurality of trays from a lower plurality of trays in a first stack of trays on a first dolly;
b) moving the lower plurality of trays and the first dolly away from the upper plurality of trays;
c) moving a second dolly below the upper plurality of trays; and
d) lowering the upper plurality of trays onto the second dolly.

14. The method of claim 13 wherein said step a) includes the step of engaging handle openings of a bottom-most tray of the upper plurality of trays with support surfaces movably mounted to a vertical structure.

15. A method for arranging trays on a dolly including the steps of:
a) lifting an upper plurality of trays from a lower plurality of trays in a first stack of trays on a first dolly;
b) removing a lower subset of trays but not all of the lower plurality of trays from a remaining subset of the lower plurality of trays on the first dolly;
c) lowering the upper plurality of trays onto the remaining subset of the lower plurality of trays on the first dolly.

16. The method of claim 15 wherein said step a) includes the step of engaging handle openings of a bottom-most tray of the upper plurality of trays with support surfaces movably mounted to a vertical structure.

17. A method for arranging trays on a dolly including the steps of:
a) providing a first plurality of trays and a first dolly;
b) lifting the first plurality of trays off of the first dolly;
c) moving the first dolly away from the first plurality of trays;
d) moving a second dolly having a second plurality of trays stacked thereon below the first plurality of trays; and
e) lowering the first plurality of trays down onto the second plurality of trays on the second dolly.

18. The method of claim 13 wherein said step b) includes the step of engaging handle openings of a bottom-most tray of the upper plurality of trays with support surfaces movably mounted to a vertical structure.

19. A method for arranging trays on a dolly including the steps of:
a) lifting an upper plurality of trays from a lower plurality of trays in a first stack of trays;
b) adding at least one additional tray onto the lower plurality of trays;
c) lowering the upper plurality of trays onto the at least one additional tray and the lower plurality of trays.

20. The method of claim 19 wherein said step a) includes the step of engaging handle openings of a bottom-most tray of the upper plurality of trays with support surfaces movably mounted to a vertical structure.
